(19) United States
(12) Patent Application Publication
(10) Pub. No.: US 2021/0160565 A1
(43) Pub. Date: May 27, 2021

(54) DECODER EQUIPMENT DELIVERING METADATA TO AUXILIARY EQUIPMENT IN ORDER TO CONTROL IT

(71) Applicant: SAGEMCOM BROADBAND SAS, RUEIL MALMAISON (FR)

(72) Inventor: Gilles BARDOUX, RUEIL MALMAISON (FR)

(21) Appl. No.: 17/104,873

(22) Filed: Nov. 25, 2020

(30) Foreign Application Priority Data
Nov. 27, 2019 (FR) 19 13316

(51) Int. Cl. H04N 21/4385

(52) U.S. Cl. CPC H04N 21/4385

(57) ABSTRACT

Decoder equipment includes first communication means arranged to receive a transport stream transporting digital television signals delivered by a television operator, the transport stream comprising a video stream, an audio stream, and metadata; second communication means arranged to communicate with auxiliary equipment that includes a controllable member; a demultiplexer arranged to extract the video stream, the audio stream, and the metadata from the transport stream; the decoder equipment being arranged to deliver the metadata via the second communication means to the auxiliary equipment, the metadata being suitable for being used by the auxiliary equipment to produce a control signal for controlling the controllable member of the auxiliary equipment in real time on the basis of the metadata.

### DESCRIPTION

The invention relates to the field of decoder equipment, e.g. decoder boxes, for receiving a transport stream (TS) transporting digital television signals.

### BACKGROUND OF THE INVENTION

A decoder box (also known as a “set-top box” (STB)) conventionally receives a transport stream transporting digital television signals. The transport stream may be delivered to the decoder box by cable, by satellite, or indeed over an Internet protocol (IP) link (e.g. a DASH link or an HLS link), i.e. via a link that makes use of an Internet protocol.

The transport stream includes a video stream comprising video samples, and an audio stream comprising audio samples.

The decoder box decodes and then synchronizes the video samples and the audio samples.

The video is then generally displayed on a television set.

The audio may be played back either by the television set, or by an audio/video amplifier, or by other audio playback equipment connected directly to the decoder box. By way of example, the audio playback equipment may be a sound bar or a smart loudspeaker.

### OBJECT OF THE INVENTION

An object of the invention is to propose new functions to a user of decoder equipment.

### SUMMARY OF THE INVENTION

In order to achieve this object, there is provided decoder equipment comprising:

first communication means arranged to receive a transport stream transporting digital television signals delivered by a television operator, the transport stream comprising a video stream, an audio stream, and metadata;

second communication means arranged to communicate with auxiliary equipment that includes a controllable member;

a demultiplexer arranged to extract the video stream, the audio stream, and the metadata from the transport stream;

the decoder equipment being arranged to deliver the metadata via the second communication means to the auxiliary equipment, the metadata being suitable for being used by the auxiliary equipment to produce a control signal for controlling the controllable member of the auxiliary equipment in real time on the basis of the metadata.

The auxiliary equipment, which is connected to the decoder equipment, is thus controlled by means of metadata included in the transport stream received by the decoder equipment. The invention thus makes it possible to perform a wide variety of functions that enable the auxiliary equipment, and thus its user, to interact in real-time with a television program.

There is also provided decoder equipment as described above, wherein each item of metadata is associated with a presentation time stamp, the decoder equipment having a first internal clock and being arranged to deliver the metadata, the presentation time stamps, and the first internal clock to the auxiliary equipment via the second communication means.

There is also provided decoder equipment as described above, wherein the decoder equipment is arranged to be connected to video playback equipment and to display the metadata in real time on a screen of the video playback equipment.

There is also provided decoder equipment as described above, the decoder equipment being arranged to display each item of metadata on the screen of the video playback equipment when the first internal clock is equal to the presentation time stamp of said item of metadata.

There is also provided decoder equipment as described above, the decoder equipment being arranged to receive first information from the auxiliary equipment via the second communication means, the first information relating to use of the auxiliary equipment, the decoder equipment also being arranged to forward the first information to the television operator via the first communication means.

There is also provided decoder equipment as described above, wherein the first information corresponds to biometric data of a user of the auxiliary equipment.

There is also provided decoder equipment as described above, the decoder equipment being arranged to receive second information from the television operator via the first communication means, the second information being produced from the first information, the second information being incorporated in the metadata, the decoder equipment also being arranged to display the second information on the screen of the video playback equipment.

There is also provided decoder equipment as described above, the decoder equipment being arranged to deliver the metadata to the auxiliary equipment by using a WebSocket protocol, the decoder equipment acting as a WebSocket server and the auxiliary equipment acting as a WebSocket client.

There is also provided decoder equipment as described above, the decoder equipment being arranged to deliver the metadata to the auxiliary equipment by using an HTTP Live Streaming protocol.

There is also provided decoder equipment as described above, the decoder equipment being a decoder box (or “set-top box” (STB)).

There is also provided a delivery method performed in decoder equipment as described above, the method comprising the steps of:

receiving the transport stream delivered by the television operator;

extracting the metadata from the transport stream;

delivering the metadata to the auxiliary equipment via the second communication means.

There is also provided a computer program including instructions for causing the decoder equipment as described above to execute the steps of the above delivery method.

There is also provided a computer readable storage medium, having stored thereon the above computer program.

There is also provided auxiliary equipment comprising:

third communication means arranged to communicate with decoder equipment, and thus to receive metadata delivered by the decoder equipment;

a controllable member;

control means arranged to acquire the metadata, to produce a control signal from the metadata, and to use the control signal to control the controllable member in real time.

There is also provided auxiliary equipment, wherein each item of metadata is associated with a presentation time stamp, the auxiliary equipment also being arranged to receive a first internal clock from the decoder equipment, the auxiliary equipment having a second internal clock and being arranged to make use of each item of metadata when:

STC2=PTS_meta−Δ

where Δ is a time offset between the first internal clock and the second internal clock, where STC2 is the second internal clock, and where PTS_meta is the presentation time stamp of said item of metadata.

There is also provided auxiliary equipment as described above, the auxiliary equipment being a smart bike, the controllable member being an inclination actuator of the smart bike, and the metadata comprising a gradient percentage.

There is also provided a method of controlling a controllable member of auxiliary equipment as described above, the method comprising the steps of:

receiving metadata delivered by the decoder equipment;

producing a control signal from the metadata;

using the control signal to control the controllable member in real time.

There is also provided a computer program including instructions for causing the auxiliary equipment as described above to execute the steps of the above control method.

There is also provided a computer readable storage medium, having stored thereon the computer program as described above.

The invention can be better understood in the light of the following description of a particular, nonlimiting embodiment of the invention.

### BRIEF DESCRIPTION OF THE DRAWINGS

Reference is made to the accompanying drawings, in which:

FIG. 1 is a diagram showing a television operator and a home in which there are to be found a gateway, a decoder box, a television set, and a smart bike;

FIG. 2 is a diagram showing the decoder box, the smart bike, and the television set;

FIG. 3 is a diagram showing the decoder box and the smart bike;

FIG. 4 shows, as a function of time, data exchanges between the television operator, the decoder box, and the smart bike.

### DETAILED DESCRIPTION OF THE INVENTION

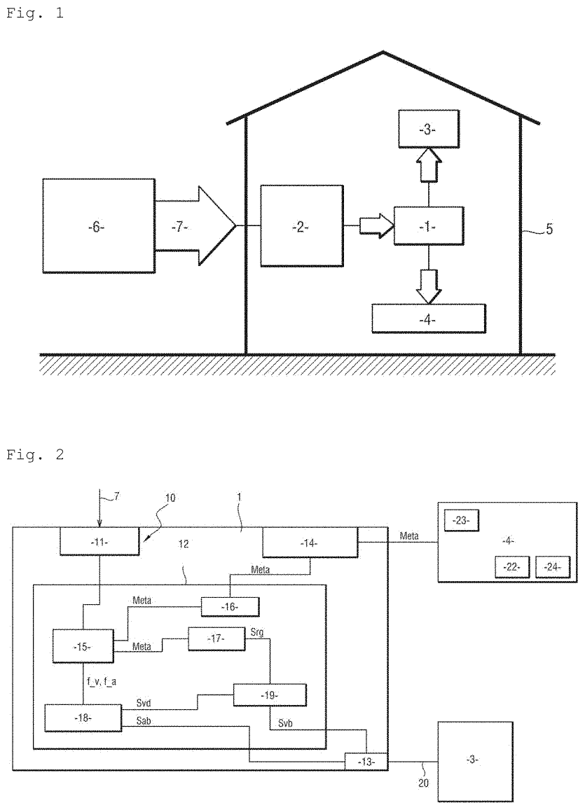

With reference to FIG. 1, decoder equipment of the invention, specifically a decoder box 1, is connected in this example to a gateway 2, to video playback equipment, specifically a television set 3, and to auxiliary equipment, specifically a smart bike 4 for indoor exercise, also known as a smart “spin” bike. The decoder box 1, the gateway 2, the television set 3, and the smart bike 4 are all located in a home 5.

From a network head unit (or “headend”), a television operator 6 generates a transport stream 7 transporting digital television signals.

In conventional manner, the transport stream 7 mainly comprises a video stream and an audio stream. The video stream is identified by a video program identifier (referred to herein as a “video PID”). The audio stream is identified by an audio program identifier (referred to herein as an “audio PID”).

The transport stream 7 thus comprises video samples and audio samples that are multiplexed. Each sample is time stamped by a presentation time stamp (PTS). The presentation time stamp defines the time at which the sample is to be rendered (i.e. played for the audio, and displayed for the video).

The transport stream 7 also transports a program clock reference (PCR).

The transport stream 7 is received by the gateway 2 and then delivered to the decoder box 1. A first internal clock is defined in the decoder box 1.

The decoder box 1 makes use of the reference clock signal to servocontrol its first internal clock and to time correctly the displaying of the samples. When the presentation time stamp of a video sample is equal to the first internal clock, the decoder box 1 displays the video sample on the screen of the television set 3. When the presentation time stamp of an audio sample is equal to the first internal clock, the decoder box 1 plays the audio sample on the internal speakers of the television set 3.

The transport stream 7 also includes data of the “metadata” type identified by a metadata identifier (referred to herein as a “metadata PID”). The metadata is used for controlling a controllable member of the smart bike 4, said controllable member being specifically an inclination actuator of the smart bike 4 (and in this example an electromechanical actuator). The inclination actuator serves to impart a controlled inclination to the smart bike 4.

In this application example, the television program being broadcast is a bicycle race and the metadata comprises parameters of the bicycle race. In this example, the bicycle race parameters include gradient percentages, and also elevation difference and wind speed values.

Each item of metadata is associated with a presentation time stamp, referred to herein as “PTS meta”.

It should be observed that there need not necessarily be a video sample or an audio sample that is presented at the same time as an item of metadata.

The metadata may be delivered in a table that is “private”, in the meaning of the standard MPEG-2 Part 1. By way of example, use is then made of the tag descriptor Metadata 0×26. For each item of metadata, the presentation time stamp associated with said item is to be found in the payload of the metadata.

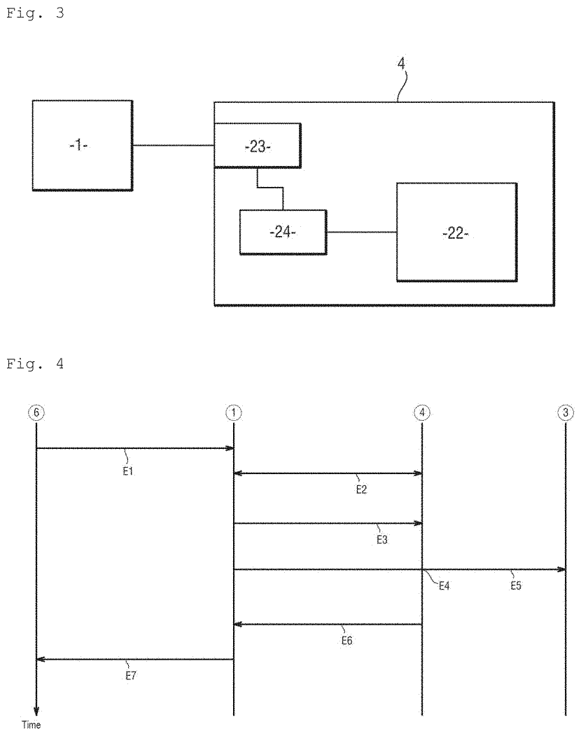

With reference to FIGS. 2 and 3 there follows a description in greater detail of the decoder box 1 and of the smart bike 4.

The decoder box 1 comprises firstly first communication means 10 via which it receives, from the gateway 2, the transport stream 7 as delivered by the television operator 6.

The first communication means 10 includes a front-end receiver 11.

The front-end receiver 11 may comprise any type of wired or wireless interface enabling it to receive the transport stream 7.

By way of example, the interface may be an Ethernet interface or a powerline carrier (PLC) interface.

The decoder box 1 further comprises a “system on chip” 12, an HDMI port 13, and second communication means 14.

The system on chip 12 comprises a demodulator 15, a first processor component 16, a graphics rendering component 17, an audio/video decoder 18, and a video and graphics mixer 19.

The first processor component 16 is adapted to execute instructions of a program for processing and sending the metadata to the smart bike 4.

By way of example, the first processor component 16 is a microcontroller, a processor, or indeed a programmable logic circuit such as a field programmable gate array (FPGA) or an application specific integrated circuit (ASIC).

The HDMI port 13 of the decoder box 1 is connected to an HDMI port of the television set 3 via an HDMI cable 20.

The second communication means 14 enable the decoder box 1 to communicate with the smart bike 4. The second communication means 14 make use of any type of technology that makes such communication possible, whether wired (e.g. Ethernet) or wireless (e.g. Bluetooth or Wi-Fi).

In addition to the inclination actuator 22, the smart bike 4 includes third communication means 23 and control means 24.

The third communication means 23 enable the smart bike 4 to communicate with the second communication means 14 of the decoder box 1.

The control means 24 include a second processor component adapted to execute instructions of a program for controlling the inclination actuator 22 and thereby inclining the smart bike 4.

By way of example, the second processor component is a microcontroller, a processor, or indeed a programmable logic circuit such as a field programmable gate array (FPGA) or an application specific integrated circuit (ASIC).

A second internal clock is defined in the smart bike 4.

With reference to FIG. 4 (and to FIG. 2) there follows a description of the way in which the decoder box 1 and the smart bike 4 co-operate.

The television operator 6 produces the transport stream 7 comprising a video stream, an audio stream, and metadata. As mentioned above, the metadata includes in particular gradient percentages.

The transport stream 7 is delivered to the decoder box 1 (step E1), which receives the transport stream 7 via its first communication means 10.

The demultiplexer 15 of the decoder box 1 extracts from the transport stream 7 both the metadata Meta (see FIG. 2), and also the video and audio streams f_v and f_a. From the video and audio streams f_v and f_a, the audio/video decoder 18 produces a decoded video signal Svd and a raw audio signal Sab.

After being acquired, formatted, and processed by the first processor component 16, the metadata is delivered to the second communication means 14 of the decoder box 1.

By using round trips of network packets and by sending the first internal clock, the smart bike 4 estimates the time offset Δ between the first internal clock (of the decoder box 1) and the second internal clock (of the smart bike 4):

Δ=STC1−STC2

where STC1 is the first internal clock and STC2 is the second internal clock (step E2).

The time offset Δ can be negative in the event of the second internal clock of the smart bike 4 being in advance relative to the first internal clock of the decoder box 1.

The first processor component 16 of the decoder box 1 delivers the metadata to the smart bike 4 via the second communication means (step E3). The first processor component 16 of the decoder box 1 also delivers the presentation time stamps and the first internal clock of the decoder box 1 to the smart bike 4 via the second communication means 14.

Via the third communication means 23, the smart bike 4 receives the metadata, the presentation time stamps, and the first internal clock.

The decoder box 1 delivers the metadata to the smart bike 4 by using a “WebSocket” protocol, the decoder box 1 acting as a WebSocket server and the smart bike 4 acting as a WebSocket client. A bidirectional channel is thus obtained between the decoder box 1 and the smart bike 4. Data can thus be sent in “push” mode from the decoder box 1 to the smart bike 4.

Naturally, some other protocol could be used. For example, the decoder box 1 could deliver the metadata to the smart bike 4 by using an HTTP Live Streaming protocol.

The smart bike 4 receives each item of metadata at a time t such that:

t<PTS_meta−Δ.

Specifically, while the transport stream 7 is being received by the decoder box 1, the presentation time stamps are always about ten seconds greater than the first internal clock of the decoder box 1. The presentation time stamps of the metadata are thus likewise about ten seconds greater than the second internal clock while they are being received by the smart bike 4.

For each item of metadata, the smart bike 4 recovers the presentation time stamp of the metadata, written PTS meta.

The metadata in question is used by the smart bike 4 when:

STC2=PTS_meta−Δ(step E4).

The second processor component of the control means 24 of the smart bike 4 acquires the metadata, produces a control signal on the basis of the metadata, and controls the inclination actuator 22 in real time by using the control signal.

Thus, if the metadata in question is a gradient percentage equal to 8%, then when:

STC2=PTS_meta−Δ

the second processor component of the control means 24 produces a control signal that controls the inclination actuator 22 in such a manner as to cause it to impart an inclination equal to 8% to the smart bike 4.

The decoder box 1 also processes the metadata, and then sends it to the television set 3 which displays it on its screen (step E5).

More precisely, the first processor component 16 and the graphics rendering component 17 of the system on chip 12 of the decoder box 1 acquire the metadata Meta. The graphics rendering component 17 produces a graphics rendering signal Srg incorporating the metadata. The video and graphics mixer 19 mixes the decoded video signal Svd and the graphics rendering signal Srg and produces a raw video signal Svb.

The raw audio signal Sab and the raw video signal Svb are then delivered to the HDMI port 13, and thus to the television set 3 via the HDMI cable 20.

The graphics rendering signal Srg is such that the gradient percentages in the metadata are displayed as a see-through display on the video in the top right corner of the screen of the television set 3. The decoder box 1 displays each item of metadata when the first internal clock of the decoder box 1 is equal to the presentation time stamp of said item of metadata.

The smart bike 4 then uses the third communication means 23 of the smart bike 4 and the second communication means 14 of the decoder box 1 to send first information to the decoder box 1 about use of the smart bike 4 (step E6). In this example, the first information comprises biometric data about the user associated with the user's activity on the smart bike 4.

The decoder box 1 then sends this first information to the television operator 6 via the first communication means 10, via the gateway 2, and via the Internet (step E7). The first information is received by the television operator 6.

On the basis of the first information, the television operator 6 produces second information and then incorporates the second information in the metadata included in the transport stream 7 and forwards it to the decoder box 1.

By way of example, the second information comprises rankings between users, as obtained from the first information (and the biometric data).

The decoder box 1 then displays the second information on the screen of the television set 3. The rankings are thus displayed by the decoder box 1 inlaid on the screen of the television set 3. Thus, the metadata present in the transport stream 7 comprises both metadata for the smart bike 4 (specifically gradient percentages), and metadata for the television set 3 (specifically the rankings of users).

This produces data that is delivered in parallel with the live transport stream and that is in the form of a loop as follows between: the television operator 6↔the decoder box 1↔the smart bike 4↔the user.

Naturally, the invention is not limited to the embodiment described, but covers any variant coming within the ambit of the invention as defined by the claims.

Above, the invention is implemented in an application in which the inclination of a smart bike is controlled on the basis of gradient percentages included in the metadata. Naturally, this application is not limiting. The auxiliary equipment need not necessarily be a smart bike, but could be any other kind of smart sports equipment (e.g. a rowing machine or a treadmill), or indeed smart equipment not associated with sport. The metadata may comprise any type of data suitable for use in controlling a controllable member of such auxiliary equipment.

The controllable member of the auxiliary equipment need not necessarily be an actuator, and the response that is controlled need not necessarily be a mechanical response. Thus, by way of example, the controllable member could be an electrical component, and control could involve adjusting an electrical parameter of said electrical component. For example, if a controllable member comprises a power amplifier, the metadata could be used for controlling the output power from the power amplifier.

The decoder equipment need not necessarily be a decoder box, but could be other equipment capable of acquiring and decoding a transport stream transporting digital television signals, e.g. a smartphone.

1. Decoder equipment comprising:
first communication means arranged to receive a transport stream transporting digital television signals delivered by a television operator, the transport stream comprising a video stream, an audio stream, and metadata;
second communication means arranged to communicate with auxiliary equipment that includes a controllable member;
a demultiplexer arranged to extract the video stream, the audio stream, and the metadata from the transport stream;
the decoder equipment being arranged to deliver the metadata via the second communication means to the auxiliary equipment, the metadata being suitable for being used by the auxiliary equipment to produce a control signal for controlling the controllable member of the auxiliary equipment in real time on the basis of the metadata.

2. The decoder equipment according to claim 1, wherein each item of metadata is associated with a presentation time stamp, the decoder equipment having a first internal clock and being arranged to deliver the metadata, the presentation time stamps, and the first internal clock to the auxiliary equipment via the second communication means.

3. The decoder equipment according to claim 1, wherein the decoder equipment is arranged to be connected to video playback equipment and to display the metadata in real time on a screen of the video playback equipment.

4. The decoder equipment according to claim 2, wherein the decoder equipment is arranged to display each item of metadata on the screen of the video playback equipment when the first internal clock is equal to the presentation time stamp of said item of metadata.

5. The decoder equipment according to claim 1, wherein the decoder equipment is arranged to receive first information from the auxiliary equipment via the second communication means, the first information relating to use of the auxiliary equipment, and the decoder equipment also is arranged to forward the first information to the television operator via the first communication means.

6. The decoder equipment according to claim 5, wherein the first information corresponds to biometric data of a user of the auxiliary equipment.

7. The equipment according to claim 3, wherein the decoder equipment is arranged to receive second information from the television operator via the first communication means, the second information is produced from the first information, the second information is incorporated in the metadata, the decoder equipment also is arranged to display the second information on the screen of the video playback equipment.

8. The equipment according to claim 1, wherein the decoder equipment is arranged to deliver the metadata to the auxiliary equipment by using a Web Socket protocol, the decoder equipment acts as a Web Socket server and the auxiliary equipment acts as a Web Socket client.

9. The decoder equipment according to claim 1, wherein the decoder equipment is arranged to deliver the metadata to the auxiliary equipment by using an HTTP Live Streaming protocol.

10. The decoder equipment according to claim 1, wherein the decoder equipment is a decoder box (or “set-top box” (STB)).

11. A delivery method performed in decoder equipment according to any preceding claim, the method comprising the steps of:
receiving the transport stream delivered by the television operator;
extracting the metadata from the transport stream;
delivering the metadata to the auxiliary equipment via the second communication means.

12. A computer program including instructions for causing the decoder equipment according to claim 1 to execute the steps of the delivery method, the method comprising the steps of:
receiving the transport stream delivered by the television operator;
extracting the metadata from the transport stream;
delivering the metadata to the auxiliary equipment via the second communication means.

13. A computer readable storage medium having stored thereon the computer program according to claim 12.

14. Auxiliary equipment comprising:
third communication means arranged to communicate with decoder equipment, and thus to receive metadata delivered by the decoder equipment;
a controllable member;
control means arranged to acquire the metadata, to produce a control signal from the metadata, and to use the control signal to control the controllable member in real time.

15. The auxiliary equipment according to claim 14, wherein each item of metadata is associated with a presentation time stamp, the auxiliary equipment also being arranged to receive a first internal clock from the decoder equipment, the auxiliary equipment having a second internal clock and being arranged to make use of each item of metadata when:
STC2=PTS_meta−Δ
where Δ is a time offset between the first internal clock and the second internal clock, where STC2 is the second internal clock, and where PTS_meta is the presentation time stamp of said item of metadata.

16. The auxiliary equipment according to claim 14, the auxiliary equipment being a smart bike, the controllable member being an inclination actuator of the smart bike, and the metadata comprising a gradient percentage.

17. A control method for controlling a controllable member of auxiliary equipment according to claim 14, the method comprising the steps of:
receiving metadata delivered by the decoder equipment;
producing a control signal from the metadata;
using the control signal to control the controllable member in real time.

18. A computer program including instructions for causing the auxiliary equipment according claim 14 to execute the steps of the control method, the method comprising the steps of:
receiving metadata delivered by the decoder equipment
producing a control signal from the metadata;
using the control signal to control the controllable member in real time.

19. A computer readable storage medium having stored thereon the computer program according to claim 18.
